(19) United States
(12) Patent Application Publication
(10) Pub. No.: US 2019/0068768 A1
(43) Pub. Date: Feb. 28, 2019

(54) PRIVACY PROTECTION SYSTEM

(71) Applicants: Rohan Garg, Frisco, TX (US); Shahin Garrossian, Frisco, TX (US); Saif Khan, Frisco, TX (US)

(72) Inventors: Rohan Garg, Frisco, TX (US); Shahin Garrossian, Frisco, TX (US); Saif Khan, Frisco, TX (US)

(21) Appl. No.: 16/119,843

(22) Filed: Aug. 31, 2018

Related U.S. Application Data
(60) Provisional application No. 62/552,500, filed on Aug. 31, 2017.

(51) Int. Cl. H04M 1/04; A45C 13/00

(52) U.S. Cl. CPC H04M 1/04; A45C 2011/002; A45C 13/005; A45C 13/002

(57) ABSTRACT

A privacy protection system enables a user to prevent unwanted and access to data collected by the camera or microphone of a cellular device. The camera is obstructed by a member in such a way as to allow light to reach the camera in an unintelligible state. The microphone is blocked by a knob to prevent sound from reaching the microphone. The member and knob are positioned by way of a case.

### BACKGROUND

### 1. Field of the Invention

The present invention relates generally to portable communication systems, and more specifically, to a privacy protection system for preventing unauthorized access to audio visual data generated by mobile phones.

### 2. Description of Related Art

Portable communication systems are well known in the art and are effective means to enable written, audio and video sharing wirelessly. For example, FIGS. 1 and 2 depict a conventional cellular phone system 101 having a casing 103 that houses a camera 105 on the back surface 107 and a microphone 201 on the bottom surface 109. During use, the microphone 201 or camera 105 are activated to send data to a recipient.

One of the problems commonly associated with system 101 is its unauthorized use. For example, third party software applications have been developed to activate the camera 105 or microphone 201 without the user's knowledge or permission. The access to the data provided by the camera 105 or microphone 201 create privacy threats for the user, rendering personal data available for unintended uses.

Personal privacy is a growing concern with the proliferation of cellular phones. The phone accompanies the user throughout the day including in circumstances not intended for outside viewing or listing. The thought of having a personal cellular phone used to spy or intrude on privacy causes worry and stress to the user even if no incursion happens.

Accordingly, although great strides have been made in the area of cellular phone systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a back view of a common cellular phone system;

FIG. 2 is a bottom view of a common cellular phone system;

FIG. 3 is a back view of a privacy protection system in accordance with a preferred embodiment of the present application;

FIG. 4 is a cross-sectional bottom view of an alternative embodiment of the member of FIG. 3;

FIG. 5 is a cross-sectional bottom view of an alternative embodiment of the member of FIG. 3;

FIG. 6 is a back view of an alternative embodiment of the system of FIG. 3;

FIG. 7 is a back view of an alternative embodiment of the knob of FIG. 3;

FIG. 8 is a cross-sectional back view of an alternative embodiment of the member of FIG. 3;

FIG. 9 is a top view of an alternative embodiment of the member of FIG. 3;

FIG. 10 is a cross-sectional top view of an alternative embodiment of the system of FIG. 3.

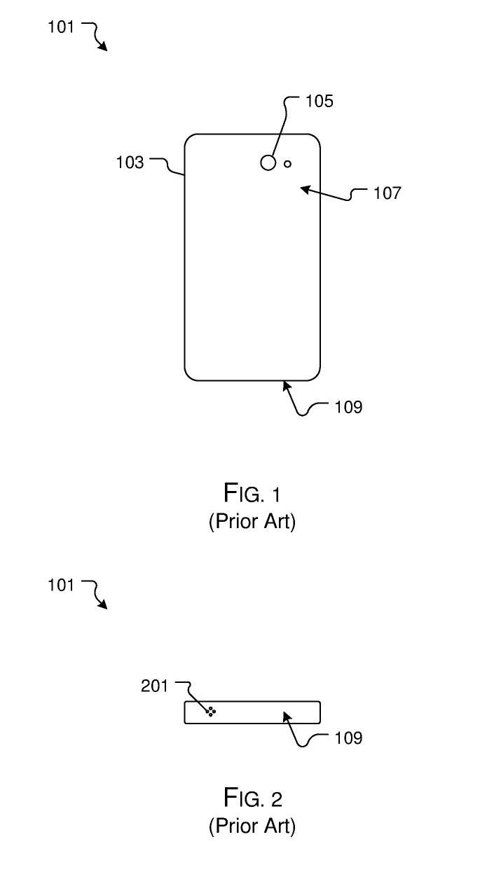

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional cellular phone systems. Specifically, the system of the present application provides efficient means of preventing usable data from being captured from the camera or microphone of a cellular phone. This and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

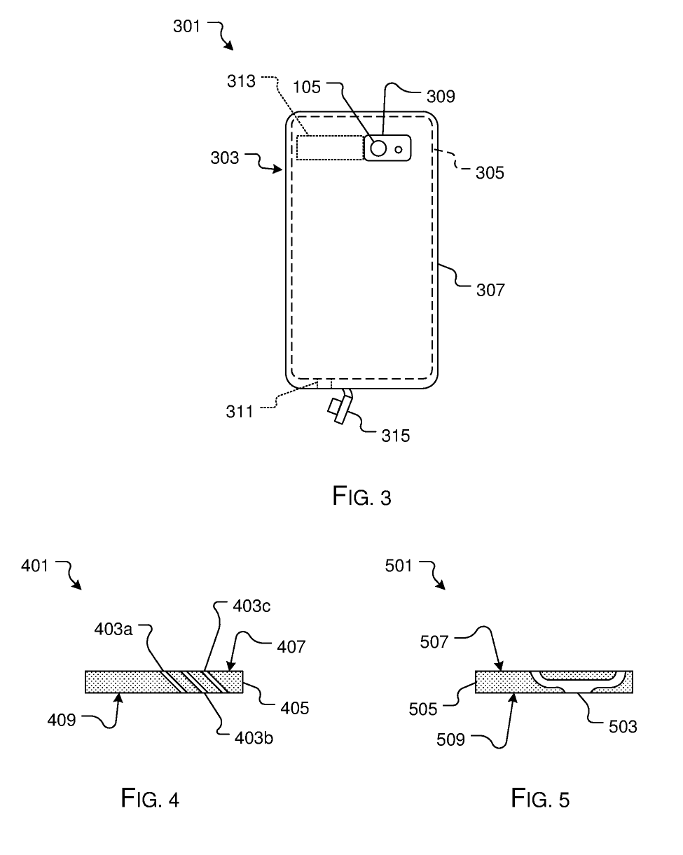

Referring now to the drawings wherein like reference characters identify corresponding or similar elements throughout the several views, FIG. 3 depicts a back view of a privacy protection system in accordance with a preferred embodiment of the present application. It will be appreciated that system 301 overcomes one or more of the above-listed problems commonly associated with conventional cellular phone systems.

In the contemplated embodiment, system 301 includes a case 303 having a body 307 with a cavity 305 wherein a cellular phone 101 is disposed. The body 303 having a first penetration 309 positioned so that the camera 105 is able to function. The body 303 having second penetration 311 positioned so that sound can enter the microphone 201.

The body 307 having a member 313 slidingly attached near the first penetration 309. The member 313 configured to cover the first penetration 309 in one position and allow unobstructed light to reach the camera 105 in a second position. The member 313 being configured to allow distorted light to reach the camera 105 while the member 313 covers the first penetration 309.

The body 307 having a knob 315 hingedly attached near the second penetration 311. The knob 315 configured to fit in the second penetration 311 in one position and allow sound to reach the microphone 201 in a second position.

It should be appreciated that one of the unique features believed characteristic of the present application is that member 313 and knob 315 protect the privacy of the user of cellular phone 101 from unauthorized access to the video and audio data.

It should be appreciated that member 313 prevents the camera 105 from capturing a distinguishable image while still allowing light to reach the camera 105. It will be understood that the camera 105 or a sensor placed next to the camera 105 are used to adjust other functions of the cellular phone 101 and the completely obstructing light from reaching the camera 105 or sensor causes the phone 101 to not function properly.

Another unique feature believed characteristic of the present application is that knob 315 prevents sound from reaching the microphone 201.

It will be appreciated that member 313 is made of translucent light path disruptive material such as privacy plastic, smart glass or the like. It will also be appreciated that member 313 could have channels that allow light to pass through the body as depicted in FIG. 4 where an alternative embodiment of member 313 is depicted. Embodiment 401 including a body 405 with channels 403 that pass from a first surface 407 to a second surface 409. The channels 403 configured to prevent a direct path for light to reach the camera 105.

Referring now to FIG. 5 an alternative embodiment of member 313 is depicted. Embodiment 501 including a body 505 with bifurcated channel 503 that passes from a first surface 507 to a second surface 509. The bifurcated channel 503 configured to prevent a direct path for light to reach the camera 105.

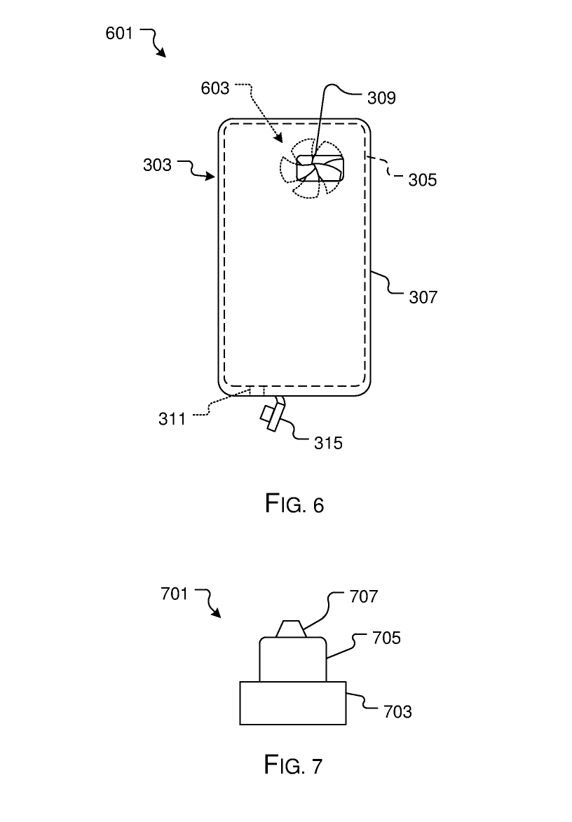

An alternative embodiment of system 301 is depicted in FIG. 6. Embodiment 601 including features similar to system 301 with member 313 being replaced by a diaphragm shutter 603.

Referring now to FIG. 7 an alternative embodiment of the knob 315 is depicted. Embodiment 701 including a support body 703 having a protrusion 705 extending from one surface. The protrusion 705 having a malleable tip 707 configured to compress against the microphone to ensure that intelligible sound waves do not reach the microphone 201.

Referring now to FIG. 8 an alternative embodiment of the member 313 is depicted. Embodiment 801 including similar features to system 301 wherein the member 313 is moved via a button 803. Button 803 is attached to member 313 by a spring 805. Button 803 protruding through the side of the body 307 through hole 807. Spring 805 configured to retract the member from blocking the camera 105.

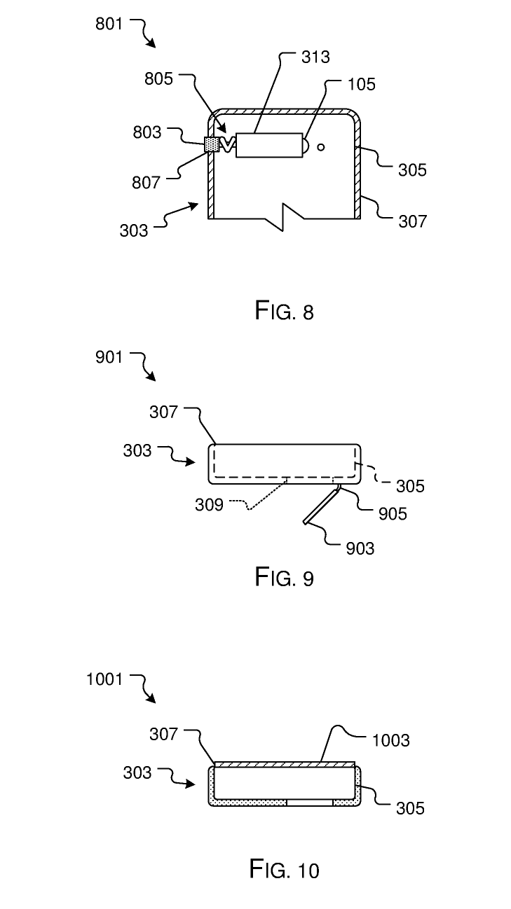

Referring now to FIG. 9 an alternative embodiment of the member 313 is depicted. Embodiment 901 having similar features to system 301 wherein member 313 is replaced by member 903 that is movably attached to body 307 via a hinge device 905. The member 903 configured to be removed from obscuring the camera 105 while still remaining attached to body via hinge 905.

Another alternative embodiment of the system 301 is depicted in FIG. 10. Embodiment 1001 includes similar features as system 301 wherein the body 307 of case 303 has a privacy screen 1001 attached to prevent unwanted access to the screen of phone 101. It will be understood that a privacy screen limits the viewable angle of the screen to the area directly in line with the screen.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A privacy protection system comprising:
a case with a cavity for holding a cellular phone therein;
the case having a first penetration to allow the camera of the phone to receive light;
a member slidingly attached to the case;
the member configured to allow unintelligible light to pass there through;
a second penetration passing through the case in proximity to the microphone of the cellular phone; and
a knob higedly attached to the case;
wherein the member slides from a first position to a second position to alternate between allowing and preventing indelible light from reaching the camera; and
wherein the knob closes the second penetration so that intelligible sound does not reach the microphone.

2. The system of claim 1 wherein the member is comprised of translucent light path disruptive material.

3. The system of claim 1 wherein the member is comprised of a body with channels passing from a first surface to a second surface wherein the channels divert light from a direct path to the camera.

4. The system of claim 1 wherein the member is comprised of a body with a bifurcated channel passing from a first surface to a second surface wherein the bifurcated channel diverts light from a direct path to the camera.

5. The system of claim 1 wherein the member is replaced by a diaphragm shutter.

6. The system of claim 1 wherein the knob comprises a protrusion with malleable material attached thereto.

7. The system of claim 1 wherein the member is removed from obscuring the camera via a button and spring.

8. The system of claim 1 wherein the member is movably attached to the body of the case via a hinge device.

9. A privacy protection system comprising:
a case with a cavity for holding a cellular phone therein;
the case having a first penetration to allow the camera of the phone to receive light;
a member configured to allow unintelligible light to pass there through;
wherein the member is a privacy screen attached to the front of the case and limits the viewable angle of the screen of a cellular phone.
